(19) United States
(12) Patent Application Publication
(10) Pub. No.: US 2016/0219633 A1
(43) Pub. Date: Jul. 28, 2016

(54) APPARATUSES AND METHODS FOR UTILIZING UNIDIRECTIONAL ANTENNAS TO AMELIORATE PEER-TO-PEER DEVICE INTERFERENCE

(71) Applicant: QUALCOMM Incorporated, San Diego, CA (US)

(72) Inventors: Lochan Verma, San Diego, CA (US); Vijayalakshmi Rajasundaram Raveendran, San Diego, CA (US)

(21) Appl. No.: 14/605,895

(22) Filed: Jan. 26, 2015

(51) Int. Cl. H04W 76/02; H04W 4/00; H04W 8/00

(52) U.S. Cl. CPC H04W 76/023; H04W 8/005; H04W 4/008

(57) ABSTRACT

Various aspects directed towards utilizing unidirectional antennas to ameliorate peer-to-peer device interference are disclosed. In a particular aspect, at least one device discovery signal is transmitted from a host device towards a cabin of a vehicle via at least one unidirectional antenna. A peer-to-peer connection request is then received at the host device from a device within the cabin in response to the at least one device discovery signal, and a peer-to-peer connection is subsequently established between the device within the cabin and the host device based on a processing of the peer-to-peer connection request.

### TECHNICAL FIELD

Aspects of the present disclosure relate generally to wireless communication systems, and more particularly, to utilizing unidirectional antennas to ameliorate peer-to-peer device interference.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). UMTS also supports enhanced 3G data communications protocols, such as High Speed Packet Access (HSPA), which provides higher data transfer speeds and capacity to associated UMTS networks.

Providing in-vehicle connectivity to wireless communication networks is particularly desirable. To this end, many vehicles are now Wi-Fi enabled, which allows drivers/passengers to access such networks from within the cabin of their vehicle. Because of the increased popularity of Wi-Fi Direct devices, many in-vehicle systems are now configured to pair with such devices. Wi-Fi Direct is a Wi-Fi standard, which is described in the Wi-Fi Peer-to-Peer (P2P) Technical Specification published by the Wi-Fi Alliance Technical Committee P2P Task Group, and incorporated herein by reference in its entirety. Wi-Fi Direct enables devices to connect easily with each other without requiring a wireless access point and to communicate at typical Wi-Fi speeds for various tasks (e.g., file transfer, Internet connectivity etc.). Moreover, Wi-Fi Direct allows two devices to establish a direct, peer-to-peer Wi-Fi connection without requiring a wireless router. For instance, as illustrated in FIG. 1, a vehicle may be equipped with a host device 100 configured to establish a peer-to-peer connection with a peer-to-peer device 110 within the vehicle according to a Wi-Fi Direct protocol. Upon establishing this peer-to-peer connection, peer-to-peer device 110 may then access secure network 120 via host device 100.

Signals from conventional in-vehicle Wi-Fi systems, however, often cause undesirable distractions to drivers. For instance, because Wi-Fi Direct device discovery transmissions from conventional in-vehicle systems typically have omnidirectional properties, transmissions from devices in neighboring vehicles often show up on a vehicle's head unit screen, which require user interaction (e.g., passcode entry, button activation, etc.). Namely, such device discovery transmissions are typically transmitted from Wi-Fi modules residing within a vehicle's dashboard via an 802.11n/ac standard operating within a 2.4-5 GHz band, which has omnidirectional antenna properties.

With the increasing popularity of vehicles with Wi-Fi Direct capability, the number of inadvertent device discovery transmissions received from neighboring vehicles will also undesirably increase. As illustrated in FIG. 2, for example, each of vehicle 200, vehicle 210, and vehicle 220 is respectively modeled to have omnidirectional antenna 202, omnidirectional antenna 212, and omnidirectional antenna 222, wherein device discovery transmissions transmitted via any of omnidirectional antenna 202, omnidirectional antenna 212, or omnidirectional antenna 222 are received by devices within a detectable range of such transmissions. While passing vehicle 220, for instance, vehicle 210 may enter the range of omnidirectional antenna 222 and thus detect a device discovery transmission transmitted from omnidirectional antenna 222. Similarly, while approaching vehicle 200 from behind, vehicle 210 may enter the range of omnidirectional antenna 202 and thus detect a device discovery transmission transmitted from omnidirectional antenna 202. As previously mentioned, however, each of these device discovery transmissions automatically appear on a vehicle's head unit, which may distract a driver. Accordingly, an in-vehicle peer-to-peer connectivity mechanism is desired whereby the aforementioned limitations of conventional systems are mitigated.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the present disclosure provide methods, apparatuses, computer program products, and processing systems directed towards utilizing unidirectional antennas to ameliorate peer-to-peer device interference. In one aspect, the disclosure provides a method, which includes transmitting at least one device discovery signal from a host device towards a cabin of a vehicle via at least one unidirectional antenna. The method further includes receiving a peer-to-peer connection request at the host device from a device within the cabin in response to the at least one device discovery signal, and establishing a peer-to-peer connection between the device within the cabin and the host device such that an establishment of the peer-to-peer connection is based on a processing of the peer-to-peer connection request.

In another aspect, a host device comprising a transmit circuit, a receive circuit, and a network circuit is disclosed. Here, the transmit circuit is configured to transmit at least one device discovery signal towards a cabin of a vehicle via at least one unidirectional antenna, whereas the receive circuit is configured to receive a peer-to-peer connection request from a device within the cabin in response to the at least one device discovery signal. The network circuit is then configured to establish a peer-to-peer connection with the device within the cabin based on a processing of the peer-to-peer connection request.

In a further aspect, another host device is disclosed, which comprises a means for transmitting a device discovery signal, a means for receiving a peer-to-peer connection request, and a means for establishing a peer-to-peer connection. Here, the means for transmitting is configured to transmit at least one device discovery signal towards a cabin of a vehicle via at least one unidirectional antenna, whereas the means for receiving is configured to receive a peer-to-peer connection request from a device within the cabin in response to the at least one device discovery signal. The means for establishing is then configured to establish a peer-to-peer connection with the device within the cabin based on a processing of the peer-to-peer connection request.

In yet another aspect, a non-transitory machine-readable storage medium having one or more instructions stored thereon is disclosed. Here, when executed by at least one processor, the one or more instructions cause the at least one processor to transmit at least one device discovery signal from a host device towards a cabin of a vehicle via at least one unidirectional antenna. The instructions further comprise instructions for causing the at least one processor to receive a peer-to-peer connection request at the host device from a device within the cabin in response to the at least one device discovery signal, and establish a peer-to-peer connection between the device within the cabin and the host device based on a processing of the peer-to-peer connection request.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates an exemplary environment for implementing a peer-to-peer connection procedure.

FIG. 2 illustrates various vehicles equipped with peer-to-peer enabled devices that utilize omnidirectional antennas in accordance with conventional systems.

FIG. 3 illustrates various vehicles equipped with peer-to-peer enabled devices that utilize unidirectional antennas in accordance with an aspect of the disclosure.

FIG. 4 illustrates an exemplary signal coverage from a unidirectional antenna according to an aspect of the disclosure.

FIG. 5 illustrates an exemplary array signal coverage from a unidirectional antenna array according to an aspect of the disclosure.

FIG. 6 illustrates a vehicle equipped with a plurality of unidirectional antenna arrays in accordance with an aspect of the disclosure.

FIG. 7 illustrates a host device comprising a rotatable unidirectional antenna according to an aspect of the disclosure.

FIG. 8 illustrates a host device comprising a rotatable unidirectional antenna array according to an aspect of the disclosure.

FIG. 9 is a block diagram illustrating an example of a hardware implementation for a host device employing a processing system.

FIG. 10 is a block diagram illustrating exemplary transmit components of a host device according to an aspect of the disclosure.

FIG. 11 is a block diagram illustrating exemplary network components of a host device according to an aspect of the disclosure.

FIG. 12 is a flow diagram illustrating an exemplary procedure for utilizing unidirectional antennas to ameliorate peer-to-peer device interference according to an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

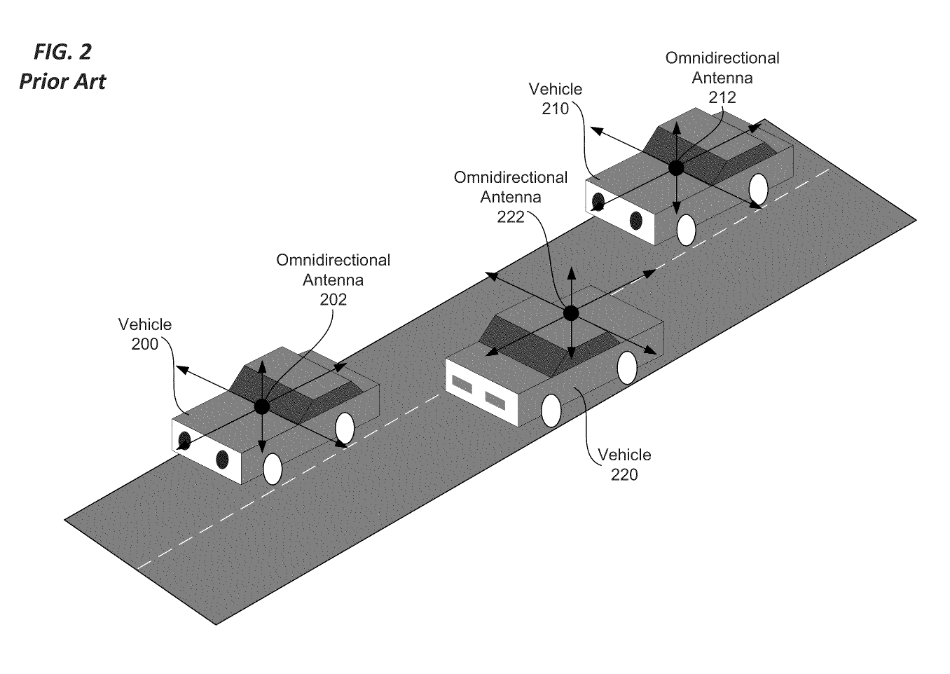

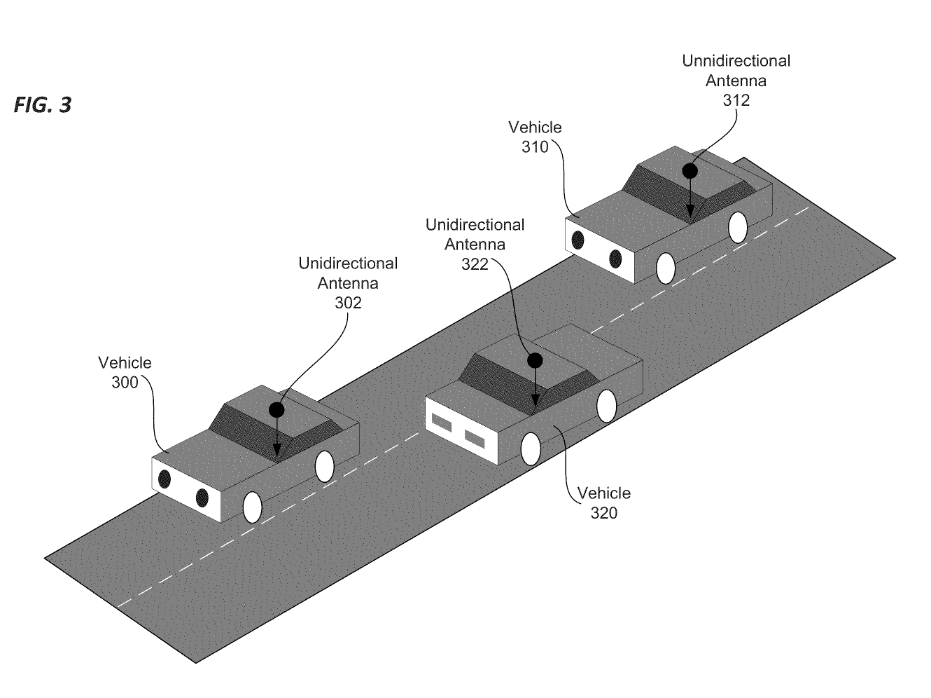

As stated previously, device discovery transmissions from conventional in-vehicle peer-to-peer systems often cause undesirable distractions to neighboring drivers. Accordingly, aspects disclosed herein are directed towards ameliorating peer-to-peer device interference caused by in-vehicle systems. In a particular implementation, unidirectional antennas are placed in the interior roof of a vehicle, wherein peer-to-peer device discovery transmissions are transmitted from the unidirectional antennas in a downward direction towards the vehicle's cabin. FIG. 3, for example, illustrates various vehicles equipped with peer-to-peer enabled devices that utilize unidirectional antennas in accordance with an aspect of the disclosure. As illustrated, each of vehicle 300, vehicle 310, and vehicle 320 are respectively equipped with unidirectional antenna 302, unidirectional antenna 312, and unidirectional antenna 322, wherein device discovery transmissions transmitted via any of unidirectional antenna 302, unidirectional antenna 312, or unidirectional antenna 322 are transmitted in a downward direction. Therefore, unlike the conventional in-vehicle systems illustrated in FIG. 2, device discovery transmissions transmitted via aspects disclosed herein are only detectable within the cabin of a vehicle, and do not emanate to neighboring vehicles.

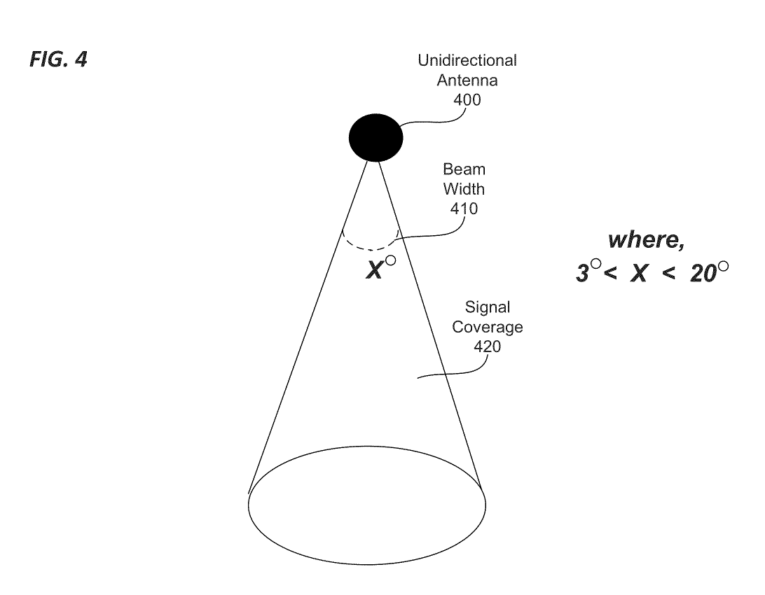

Referring next to FIG. 4, an exemplary signal coverage from a unidirectional antenna is shown according to an aspect of the disclosure. As illustrated, unidirectional antenna 400 may be configured to transmit signals having a beam width 410 and generating signal coverage 420. In a particular implementation, unidirectional antenna 400 is a millimeter wave antenna configured to transmit signals via an 802.11ad standard at approximately 60 GHz. Here, it should be appreciated that such configuration yields unidirectional antenna properties, wherein beam width 410 is approximately between three degrees and twenty degrees.

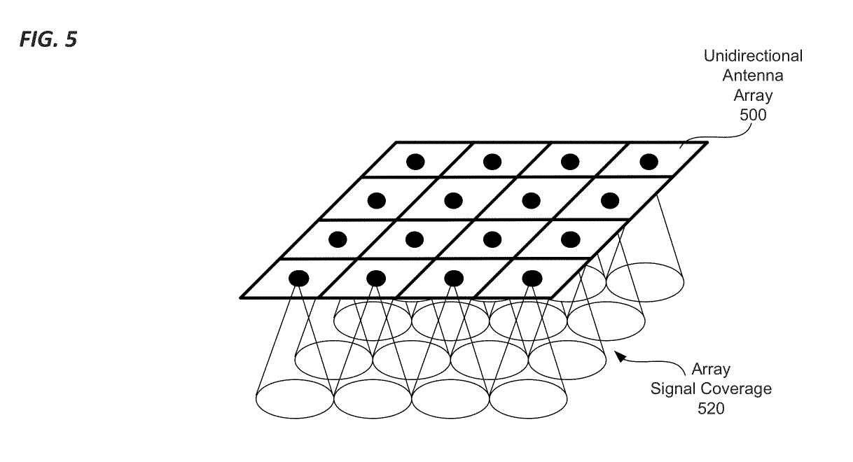

Depending on the desired coverage area, it may be desirable to transmit signals via multiple unidirectional antennas. Indeed, because of the aforementioned characteristics of beam width 410, adequate signal coverage of a vehicle's cabin may require an array of unidirectional antennas, rather than a single antenna. In FIG. 5, an exemplary array signal coverage from a unidirectional antenna array is shown according to an aspect of the disclosure. As illustrated, unidirectional antenna array 500 is configured to provide array signal coverage 520, wherein array signal coverage 520 encompasses an area that includes the combined signal coverage of each antenna within unidirectional antenna array 500. For this particular example, although unidirectional antenna array 500 is shown as a 4×4 array, it should be appreciated that any of a plurality of array dimensions may be used (e.g., 6×6 array, 8×8 array, etc.), wherein such dimensions may be selected according to any of various design specifications (e.g., throughput requirements, desired beam width, etc.).

In another aspect of the disclosure, it is contemplated that the spacing between individual antennas of an array may be strategically selected according to the desired transmitting frequency of the antennas. For instance, in an exemplary implementation, the spacing between unidirectional antennas is selected to be approximately half the wavelength of signals transmitted from the antennas. Therefore, if a desired configuration comprises transmitting device discovery transmissions at 60 Ghz, a spacing of approximately 2.5 millimeters may be selected since signals transmitted at 60 Ghz have a wavelength of approximately 5 millimeters.

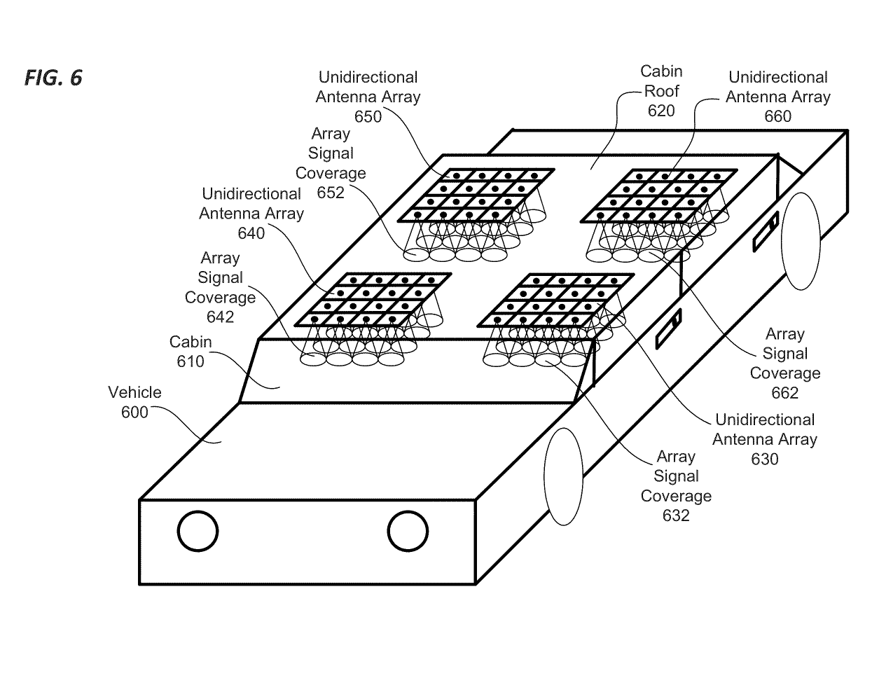

For some implementations, signal coverage may be provided for select areas within the cabin of a vehicle. Namely, rather than attempting to provide exhaustive signal coverage for the entire cabin, signal coverage may instead be limited to areas of the cabin in which a peer-to-peer device will likely be used. Unidirectional antennas, either individually or in a plurality of arrays, may then be placed in the interior roof of the cabin above these selected areas. In FIG. 6, for instance, an exemplary vehicle equipped with a plurality of unidirectional antenna arrays is provided in accordance with an aspect of the disclosure. For this particular example, signal coverage is limited to the seating area of a driver and three passengers, as shown. Specifically, each of unidirectional antenna array 630, unidirectional antenna array 640, unidirectional antenna array 650, and unidirectional antenna array 660 are placed on cabin roof 620 so as to respectively provide array signal coverage 632, array signal coverage 642, array signal coverage 652, and array signal coverage 662 within cabin 610 of vehicle 600.

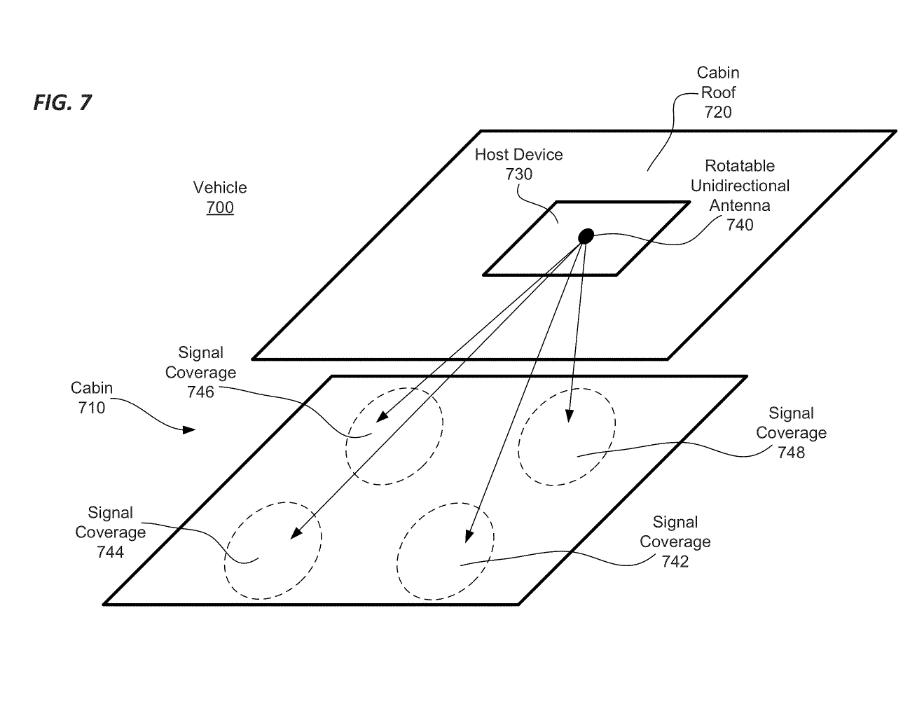

In a further aspect of the disclosure, utilizing rotatable unidirectional antennas to provide signal coverage is contemplated. To this end, it should be appreciated that such antennas may be configured to rotate so as to point towards an area within the cabin for which signal coverage is desired. In FIG. 7, for instance, a host device comprising an exemplary rotatable unidirectional antenna is provided according to an aspect of the disclosure. As illustrated, host device 730 is placed on cabin roof 720 and comprises rotatable unidirectional antenna 740, wherein rotatable unidirectional antenna 740 is configured to point towards various areas within cabin 710 of vehicle 700. Accordingly, rotatable unidirectional antenna 740 may provide signal coverage to any of the various areas of which rotatable unidirectional antenna 740 can point towards including, but not limited to, signal coverage 742, signal coverage 744, signal coverage 746, and/or signal coverage 748.

Here, although it is contemplated rotatable unidirectional antenna 740 may be rotated manually, it is also contemplated that such rotation may be performed via an automated electromechanical mechanism. For instance, any of various types of sensors may be used to determine a desired direction to rotate rotatable unidirectional antenna 740. A sensor may, for example, detect a signal from a peer-to-peer device and subsequently determine an approximate location of the device within the cabin. Host device 730 may then be configured to automatically rotate rotatable unidirectional antenna 740 toward the determined location to establish a peer-to-peer connection.

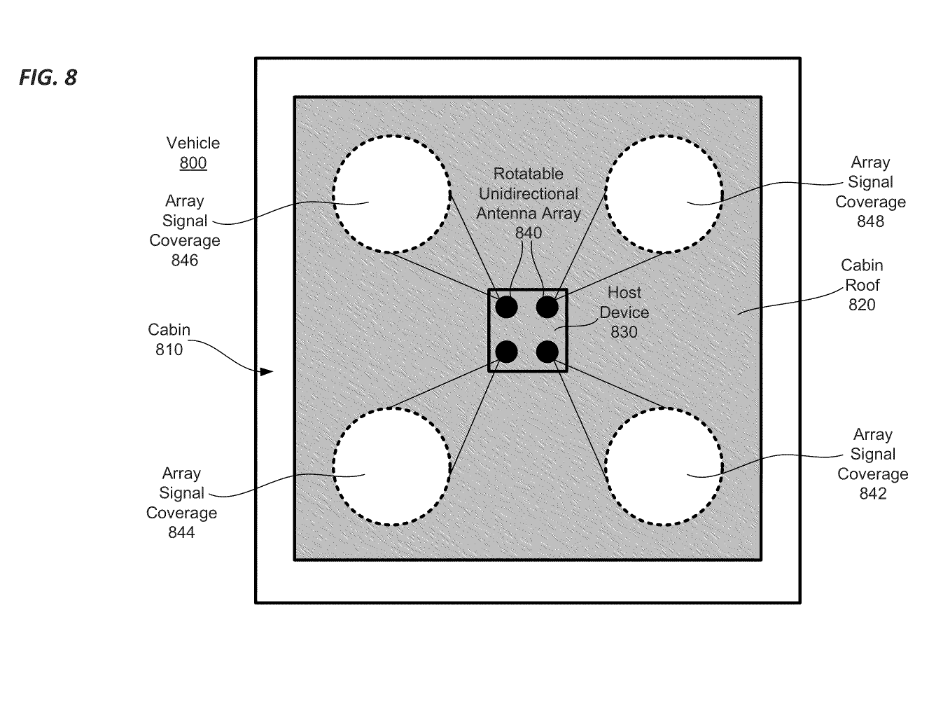

In yet a further aspect of the disclosure, utilizing an array of rotatable unidirectional antennas to provide signal coverage is contemplated. In FIG. 8, for instance, a host device comprising an exemplary rotatable unidirectional antenna array is provided according to an aspect of the disclosure. Here, it should be noted that FIG. 8 is a bottom view from within cabin 810 of vehicle 800. As illustrated, host device 830 is placed on cabin roof 820 and comprises rotatable unidirectional antenna array 840, wherein each of the antennas within rotatable unidirectional antenna array 840 is configured to point towards various areas within cabin 810 of vehicle 800. Accordingly, the antennas within rotatable unidirectional antenna array 840 may provide signal coverage, either individually or collectively, to any of the various areas of which the antennas within rotatable unidirectional antenna array 840 can point towards including, but not limited to, array signal coverage 842, array signal coverage 844, array signal coverage 846, and/or array signal coverage 848. To this end, although the antennas within rotatable unidirectional antenna array 840 are shown as respectively pointing towards different areas, it should be appreciated that any combination of the antennas within rotatable unidirectional antenna array 840 may point towards a particular area. For instance, in a first exemplary use, each of the antennas within rotatable unidirectional antenna array 840 may point towards array signal coverage 842. In another exemplary use, however, half of the antennas within rotatable unidirectional antenna array 840 may point towards array signal coverage 842, whereas the other half may point towards array signal coverage 844.

It is contemplated that the various aspects for utilizing unidirectional antennas to ameliorate peer-to-peer device interference disclosed herein may be incorporated within a peer-to-peer enabled device (e.g., host device 100, host device 730, host device 830, etc.). Accordingly, exemplary implementations of these aspects are provided below, as incorporated within a peer-to-peer enabled device.

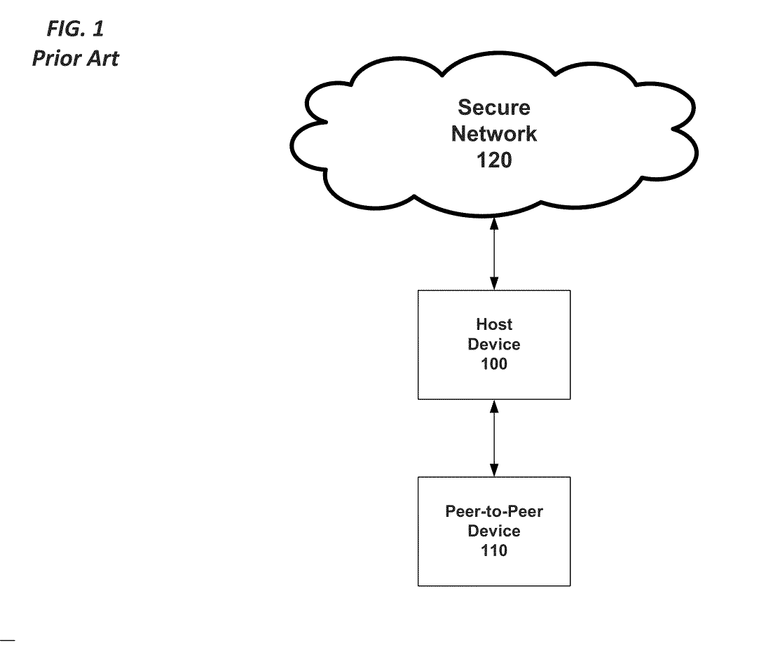

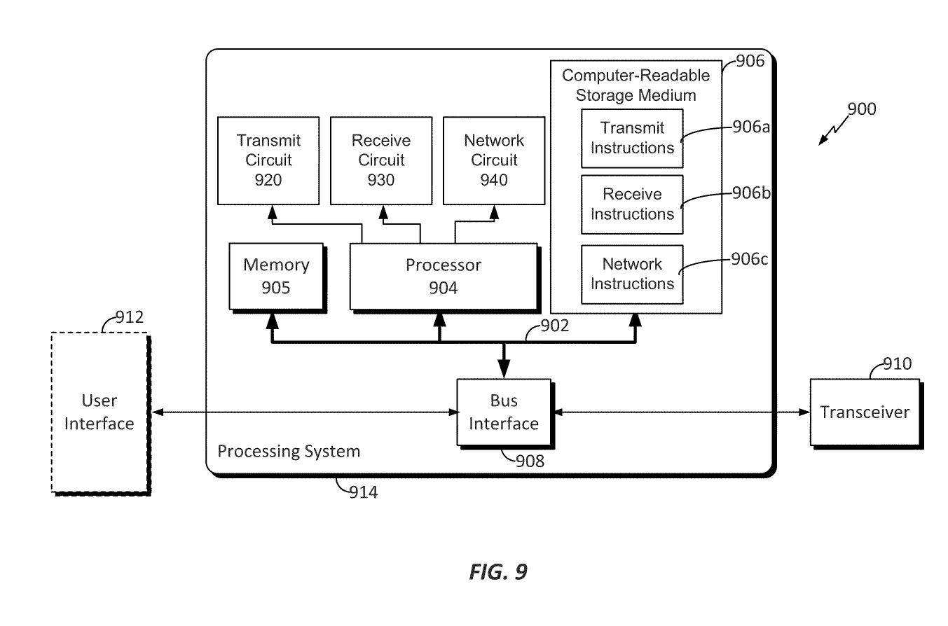

Referring next to FIG. 9, a conceptual diagram illustrating an example of a hardware implementation for a host device 900 employing a processing system 614 is provided. It is contemplated that host device 900 may be any peer-to-peer enabled device configured to include the aspects disclosed herein including, for example, any of the host devices discussed with reference to FIGS. 1-8. In accordance with various aspects of the disclosure, an element, or any portion of an element, or any combination of elements may be implemented with a processing system 914 that includes one or more processors 904. Examples of processors 904 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 904, as utilized in host device 900, may be used to implement any one or more of the processes described herein.

In this example, the processing system 914 may be implemented with a bus architecture, represented generally by the bus 902. The bus 902 may include any number of interconnecting buses and bridges depending on the specific application of the processing system 914 and the overall design constraints. The bus 902 links together various circuits including one or more processors (represented generally by the processor 904), a memory 905, and computer-readable media (represented generally by the computer-readable medium 906). The bus 902 may also link various other circuits such as timing sources, peripherals, voltage regulators, and power management circuits, which are well known in the art, and therefore, will not be described any further. A bus interface 908 provides an interface between the bus 902 and a transceiver 910. The transceiver 910 provides a means for communicating with various other apparatus over a transmission medium. Depending upon the nature of the apparatus, a user interface 912 (e.g., keypad, display, speaker, microphone, joystick) may also be provided.

In an aspect of the disclosure, computer-readable medium 906 is configured to include various instructions 906a, 906b, and/or 906c to facilitate utilizing unidirectional antennas to ameliorate peer-to-peer device interference, as shown. In a similar aspect, such utilization can instead be implemented via hardware by coupling processor 904 to any of circuits 920, 930, and/or 940, as shown. Moreover, it is contemplated that the utilization of unidirectional antennas disclosed herein may be performed by any combination of instructions 906a, 906b, and/or 906c, with any combination of circuits 920, 930, and/or 940.

The processor 904 is responsible for managing the bus 902 and general processing, including the execution of software stored on the computer-readable medium 906. The software, when executed by the processor 904, causes the processing system 914 to perform the various functions described below for any particular apparatus. The computer-readable medium 906 may also be used for storing data that is manipulated by the processor 904 when executing software.

One or more processors 904 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 906. The computer-readable medium 906 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 906 may reside in the processing system 914, external to the processing system 914, or distributed across multiple entities including the processing system 914. The computer-readable medium 906 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

As discussed below, host device 900 may be configured in any of a plurality of ways to facilitate utilizing unidirectional antennas to ameliorate peer-to-peer device interference. For instance, in an exemplary implementation, transmit instructions 906a and/or transmit circuit 920 may be configured to transmit at least one device discovery signal towards a cabin of a vehicle via at least one unidirectional antenna; receiving instructions 906b and/or receiving circuit 930 may be configured to receive a peer-to-peer connection request from a device within the cabin in response to the at least one device discovery signal; and network instructions 906c and/or network circuit 940 may be configured to establish a peer-to-peer connection with the device within the cabin based on a processing of the peer-to-peer connection request.

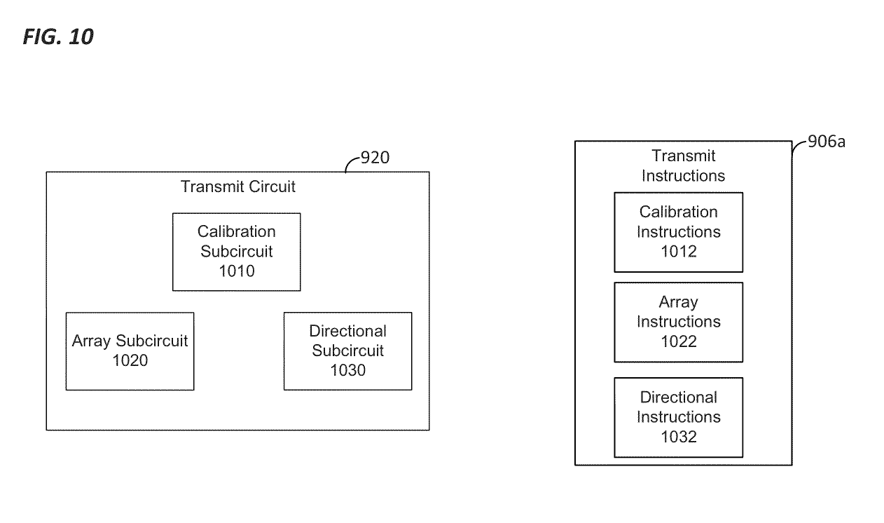

As illustrated in FIG. 10, each of transmit instructions 906a and transmit circuit 920 may further comprise any of a plurality of subcomponents to facilitate implementing various aspects disclosed herein. For instance, it is contemplated that calibration instructions 1012 and/or calibration sub-circuit 1010 may be configured to calibrate the device discovery signal(s) transmitted from host device 900. To this end, it should be appreciated that such calibrations may comprise calibrating any of various transmission characteristics (e.g., frequency, beam width, signal strength, etc.), wherein particular calibrations may depend on the hardware of host device 900. For example, if the at least one unidirectional antenna of host device 900 is a millimeter wave antenna, calibration instructions 1012 and/or calibration sub-circuit 1010 may be configured to calibrate device discovery signal transmissions accordingly. In a particular implementation, a millimeter wave antenna is utilized to transmit device discovery signals at a frequency of 60 GHz and having a beam width between three degrees and twenty degrees.

In an aspect of the disclosure, transmit instructions 906a and transmit circuit 920 may further comprise subcomponents to facilitate transmitting device discovery signals via unidirectional antenna arrays (e.g., unidirectional antenna array 500). For instance, as illustrated in FIG. 10, array instructions 1022 and/or array sub-circuit 1020 may be included, wherein either of array instructions 1022 and/or array sub-circuit 1020 may be configured to facilitate transmitting a plurality of device discovery signals via at least one array of unidirectional antennas. In a particular aspect, it is contemplated that information ascertained from array instructions 1022 and/or array sub-circuit 1020 may be utilized by calibration instructions 1012 and/or calibration sub-circuit 1010 to calibrate device discovery signal transmissions accordingly. Information regarding an array's dimensions, for example, may be utilized by calibration instructions 1012 and/or calibration sub-circuit 1010 for load balancing purposes. Information regarding a spacing of the unidirectional antennas may also be utilized, wherein calibration instructions 1012 and/or calibration sub-circuit 1010 may be configured to calibrate device discovery signal transmissions to transmit at a frequency associated with the spacing of the unidirectional antennas. For instance, in an exemplary implementation, the spacing between unidirectional antennas is selected to be approximately half the wavelength of the device discovery signals. Here, since device discovery signals transmitted at 60 Ghz have a wavelength of approximately 5 millimeters, the spacing between unidirectional antennas transmitting at 60 Ghz would thus be approximately 2.5 millimeters for this particular implementation.

As previously mentioned, because it may be desirable for a vehicle to have multiple unidirectional antenna arrays (e.g., vehicle 600 which includes unidirectional antenna array 630, unidirectional antenna array 640, unidirectional antenna array 650, and unidirectional antenna array 660), array instructions 1022 and/or array sub-circuit 1020 may be configured to facilitate transmitting the plurality of device discovery signals via a plurality of unidirectional antenna arrays. To conserve power, for example, array instructions 1022 and/or array sub-circuit 1020 may be coupled to a triggering mechanism, wherein the triggering mechanism activates particular arrays upon detecting that a user/device is within an array signal coverage area. Here, it is contemplated that any of various triggering mechanisms may be used. For instance, a sensor configured to detect whether a driver/passenger is seated within an array signal coverage area may be utilized, wherein such sensor may be any sensor commonly known in the art (e.g., optical sensor, heat sensor, weight sensor, etc.). A signal sensor may also be utilized, wherein such sensor detects signals emanating from peer-to-peer devices and activates arrays accordingly.

In a further aspect of the disclosure, as illustrated in FIG. 10, transmit instructions 906a and transmit circuit 920 may further comprise directional instructions 1032 and directional sub-circuit 1030, respectively, to facilitate transmitting device discovery signals in a desired direction. In a particular implementation, directional instructions 1032 and/or directional sub-circuit 1030 may be configured to transmit at least one device discovery signal in a downward direction from a roof of the vehicle towards the cabin of the vehicle. As previously mentioned, however, any of various configurations may be implemented to yield such downward directed transmissions. For example, as illustrated in FIG. 7, a single rotatable unidirectional antenna may provide downward directed transmissions, wherein directional instructions 1032 and/or directional sub-circuit 1030 may be configured to point the rotatable unidirectional antenna in a desired direction. Alternatively, as illustrated in FIG. 8, an array of rotatable unidirectional antennas may be used instead of a single antenna, wherein directional instructions 1032 and/or directional sub-circuit 1030 may be configured to point rotatable unidirectional antennas of the array, individually or in combination, in a desired direction. As previously mentioned, it is also contemplated that the rotatable unidirectional antennas may be rotated manually, rather than via directional instructions 1032 and/or directional sub-circuit 1030,

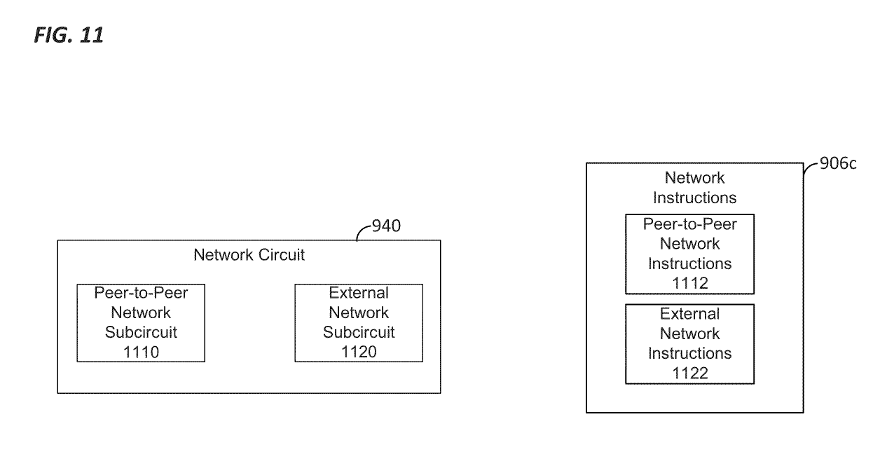

In accordance with another aspect of the disclosure, each of network instructions 906c and network circuit 940 may comprise any of a plurality of subcomponents to facilitate establishing peer-to-peer connections between host device 900 and devices within the cabin of a vehicle. For instance, as illustrated in FIG. 11, it is contemplated that network instructions 906c and network circuit 940 may comprise peer-to-peer network instructions 1112 and peer-to-peer network sub-circuit 1110, respectively, to facilitate interfacing host device 900 with other peer-to-peer devices. With respect to establishing peer-to-peer connections, for example, peer-to-peer network instructions 1112 and/or peer-to-peer network sub-circuit 1110 may be configured to follow a Wi-Fi Direct protocol. Here, it is contemplated that such protocol may comprise negotiating the peer-to-peer connections via a Wi-Fi Protected Setup system that assigns each device a limited wireless access point.

Implementations where host device 900 connects peer-to-peer devices to external networks are also contemplated. To facilitate such connections, network instructions 906c and network circuit 940 may comprise external network instructions 1122 and external network sub-circuit 1120, respectively. For instance, because it may be desirable for host device 900 to provide peer-to-peer devices with internet access via a secure network, external network instructions 1122 and/or external network sub-circuit 1120 may be configured to store/process credentials associated with accessing such secure network.

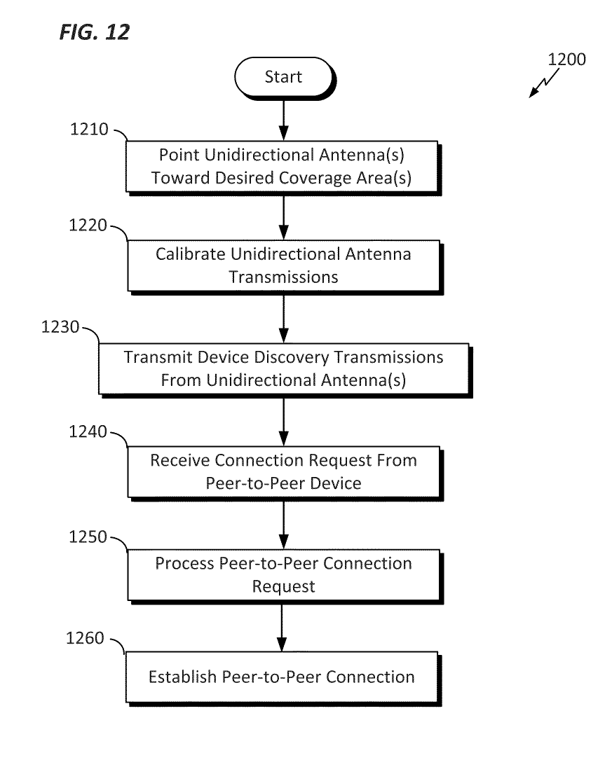

Referring next to FIG. 12, a flow diagram illustrating an exemplary procedure for utilizing unidirectional antennas to ameliorate peer-to-peer device interference according to the aforementioned aspect of the disclosure is provided. Process 1200 includes a series of acts that may be performed within a peer-to-peer enabled computing device (e.g., host device 100, host device 730, host device 830, host device 900, etc.) according to an aspect of the subject specification. For instance, process 1200 may be implemented by employing a processor to execute computer executable instructions stored on a computer readable storage medium to implement the series of acts. In another implementation, a computer-readable storage medium comprising code for causing at least one computer to implement the acts of process 1200 is contemplated.

As illustrated, process 1200 begins at act 1210 where a unidirectional antenna or antenna array is pointed toward a desired signal coverage area. As previously stated, it is contemplated that unidirectional antennas are pointed downward from the interior roof of a vehicle's cabin so that signals transmitted from the antennas are directed towards the cabin. At act 1220, the unidirectional antennas are then calibrated to transmit signals as desired. For instance, such calibration may comprise calibrating a millimeter wave to transmit signals at a particular frequency (e.g., 60 GHz) and having a particular beam width (e.g., between three degrees and twenty degrees).

Once the unidirectional antennas are properly calibrated, a procedure for establishing a peer-to-peer connection may commence. Such procedure may, for example, include establishing a peer-to-peer connection via a Wi-Fi Direct protocol. Accordingly, at act 1230 device discovery signals may be transmitted from the unidirectional antennas to find peer-to-peer devices within the cabin of the vehicle. If a peer-to-peer device is within a coverage area of the device discovery transmissions, the peer-to-peer device then sends a connection request to the host device which is received at act 1240. Process 1200 then proceeds to act 1250 where the connection request is processed (e.g., via a Wi-Fi Protected Setup), and subsequently concludes at act 1260 with the host device establishing a peer-to-peer connection with the peer-to-peer device according to a processing of the connection request.

Several aspects of a telecommunications system have been presented with reference to a system utilizing a peer-to-peer architecture and a Wi-Fi (e.g., 802.11) air interface. As those skilled in the art will readily appreciate, various aspects described throughout this disclosure may be extended to other communication systems, network architectures and communication standards.

By way of example, various aspects may be extended to other systems such as those employing Long Term Evolution (LTE) (in FDD, TDD, or both modes), LTE-Advanced (LTE-A) (in FDD, TDD, or both modes), Universal Mobile Telecommunications Systems (UMTS), Global System for Mobile (GSM), CDMA2000, Evolution-Data Optimized (EV-DO), Ultra Mobile Broadband (UMB), IEEE 802.16 (WiMAX), IEEE 802.20, Ultra-Wideband (UWB), Bluetooth, and/or other suitable systems. The actual communication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-12 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-12 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method to ameliorate peer-to-peer device interference comprising:
transmitting at least one device discovery signal from a host device via at least one unidirectional antenna, wherein the at least one unidirectional antenna is configured to transmit the at least one device discovery signal towards a cabin of a vehicle;
receiving a peer-to-peer connection request at the host device, the peer-to-peer connection request received from a device within the cabin in response to the at least one device discovery signal transmitted from the host device; and
establishing a peer-to-peer connection between the device within the cabin and the host device, wherein an establishment of the peer-to-peer connection is based on a processing of the peer-to-peer connection request.

2. The method according to claim 1, wherein the at least one unidirectional antenna is a millimeter wave antenna.

3. The method according to claim 2, wherein the transmitting comprises calibrating a transmission of the at least one device discovery signal to transmit at a frequency of 60 GHz.

4. The method according to claim 1, wherein the transmitting comprises calibrating a transmission of the at least one device discovery signal to have a beam width between three degrees and twenty degrees.

5. The method according to claim 1, wherein the transmitting comprises transmitting a plurality of device discovery signals via at least one array of unidirectional antennas.

6. The method according to claim 5, wherein the transmitting comprises calibrating a transmission of the plurality of device discovery signals to transmit at a frequency associated with a spacing of the unidirectional antennas.

7. The method according to claim 5, wherein the transmitting comprises transmitting the plurality of device discovery signals via a plurality of unidirectional antenna arrays.

8. The method according to claim 1, wherein the transmitting comprises transmitting the at least one device discovery signal in a downward direction from a roof of the vehicle towards the cabin of the vehicle.

9. The method according to claim 1, wherein the establishing further comprises enabling the device within the cabin to access an external network via the host device.

10. The method according to claim 1, wherein the establishing comprises establishing the peer-to-peer connection via a Wi-Fi Direct protocol.

11. A host device comprising:
a transmit circuit configured to transmit at least one device discovery signal via at least one unidirectional antenna, wherein the at least one unidirectional antenna is configured to transmit the at least one device discovery signal towards a cabin of a vehicle;
a receive circuit configured to receive a peer-to-peer connection request from a device within the cabin in response to the at least one device discovery signal; and
a network circuit configured to establish a peer-to-peer connection with the device within the cabin, wherein an establishment of the peer-to-peer connection is based on a processing of the peer-to-peer connection request.

12. The host device according to claim 11, wherein the at least one unidirectional antenna is a millimeter wave antenna.

13. The host device according to claim 12, wherein the transmit circuit comprises a calibration subcircuit configured to calibrate a transmission of the at least one device discovery signal to transmit at a frequency of 60 GHz.

14. The host device according to claim 11, wherein the transmit circuit comprises a calibration subcircuit configured to calibrate a transmission of the at least one device discovery signal to have a beam width between three degrees and twenty degrees.

15. The host device according to claim 11, wherein the transmit circuit comprises an array subcircuit configured to facilitate transmitting a plurality of device discovery signals via at least one array of unidirectional antennas.

16. The host device according to claim 15, wherein the array subcircuit is configured to ascertain a spacing of the unidirectional antennas, and wherein the transmit circuit further comprises a calibration subcircuit configured to calibrate a transmission of the plurality of device discovery signals to transmit at a frequency associated with the spacing of the unidirectional antennas.

17. The host device according to claim 15, wherein the array subcircuit is configured to facilitate transmitting the plurality of device discovery signals via a plurality of unidirectional antenna arrays.

18. The host device according to claim 11, wherein the transmit circuit further comprises a directional subcircuit configured to facilitate transmitting the at least one device discovery signal in a downward direction from a roof of the vehicle towards the cabin of the vehicle.

19. The host device according to claim 11, wherein the network circuit further comprises an external network subcircuit configured to enable the device within the cabin to access an external network via the host device.

20. The host device according to claim 11, wherein the network circuit further comprises a peer-to-peer network subcircuit configured to establish the peer-to-peer connection via a Wi-Fi Direct protocol.

21. A host device comprising:
means for transmitting at least one device discovery signal from the host device via at least one unidirectional antenna, wherein the at least one unidirectional antenna is configured to transmit the at least one device discovery signal towards a cabin of a vehicle;
means for receiving a peer-to-peer connection request at the host device, the peer-to-peer connection request received from a device within the cabin in response to the at least one device discovery signal transmitted from the host device; and
means for establishing a peer-to-peer connection between the device within the cabin and the host device, wherein an establishment of the peer-to-peer connection is based on a processing of the peer-to-peer connection request.

22. The host device according to claim 21, wherein the at least one unidirectional antenna is a millimeter wave antenna.

23. The host device according to claim 22, wherein the means for transmitting comprises means for calibrating a transmission of the at least one device discovery signal to transmit at a frequency of 60 GHz.

24. The host device according to claim 21, wherein the means for transmitting comprises means for calibrating a transmission of the at least one device discovery signal to have a beam width between three degrees and twenty degrees.

25. The host device according to claim 21, wherein the means for transmitting comprises means for transmitting a plurality of device discovery signals via at least one array of unidirectional antennas.

26. A non-transitory machine-readable storage medium having one or more instructions stored thereon, which when executed by at least one processor causes the at least one processor to:
transmit at least one device discovery signal from a host device via at least one unidirectional antenna, wherein the at least one unidirectional antenna is configured to transmit the at least one device discovery signal towards a cabin of a vehicle;
receive a peer-to-peer connection request at the host device, the peer-to-peer connection request received from a device within the cabin in response to the at least one device discovery signal transmitted from the host device; and
establish a peer-to-peer connection between the device within the cabin and the host device, wherein an establishment of the peer-to-peer connection is based on a processing of the peer-to-peer connection request.

27. The non-transitory machine-readable storage medium of claim 26, wherein the at least one unidirectional antenna is a millimeter wave antenna.

28. The non-transitory machine-readable storage medium of claim 26, the one or more instructions further comprising instructions to cause the at least one processor to transmit the at least one device discovery signal in a downward direction from a roof of the vehicle towards the cabin of the vehicle.

29. The non-transitory machine-readable storage medium of claim 26, the one or more instructions further comprising instructions to cause the at least one processor to enable the device within the cabin to access an external network via the host device.

30. The non-transitory machine-readable storage medium of claim 26, the one or more instructions further comprising instructions to cause the at least one processor to establish the peer-to-peer connection via a Wi-Fi Direct protocol.
